(19) United States
(12) Patent Application Publication
(10) Pub. No.: US 2011/0162622 A1
(43) Pub. Date: Jul. 7, 2011

(54) FUEL SUPPLY APPARATUS AND FUEL SUPPLY METHOD FOR INTERNAL COMBUSTION ENGINE

(75) Inventors: Susumu Kojima, Shizuoka-ken (JP); Tomojiro Sugimoto, Shizuoka-ken (JP)

(73) Assignee: TOYOTA JIDOSHA KABUSHIKI KAISHA

(21) Appl. No.: 13/119,872

(22) PCT Filed: Sep. 18, 2009
(86) PCT No.: PCT/IB09/06880

§ 371 Date: Mar. 18, 2011

(30) Foreign Application Priority Data
Sep. 19, 2008 (JP) 2008-24820

(51) Int. Cl. F02M 69/54

(52) U.S. Cl. 123/457

(57) ABSTRACT

In a fuel supply apparatus for an internal combustion engine, fuel is delivered to a high pressure fuel pump driven by an internal combustion engine, using an electrically-operated low pressure fuel pump, and the fuel pressurized by the high pressure fuel pump is supplied to the internal combustion engine. The fuel supply apparatus includes a low pressure pump control portion that controls the low pressure fuel pump to avoid a discharge failure in the high pressure fuel pump due to insufficiency of a feed pressure at which the low pressure fuel pump delivers the fuel to the high pressure fuel pump. The low pressure pump control portion stops the low pressure fuel pump in a case where the discharge failure in the high pressure fuel pump is avoided even when the feed pressure is equal to a gauge pressure of 0.

### BACKGROUND OF THE INVENTION

1. Field of the Invention

The invention relates to a fuel supply apparatus and a fuel supply method for an internal combustion engine, in which fuel is delivered to a high pressure fuel pump driven by an internal combustion engine, using an electrically-operated low pressure fuel pump, and the fuel pressurized by the high pressure fuel pump is supplied to the internal combustion engine.

2. Description of the Related Art

Japanese Patent Application Publication No. 2005-307931 (JP-A-2005-307931) describes a fuel supply apparatus for an internal combustion engine, in which a target fuel pressure is decreased to a value lower than a lower limit value of a normal range in a control of a discharge amount of a low pressure fuel pump, when a high pressure fuel pump supplies an excessive amount of the fuel. Japanese Patent Application Publication No. 11-210582 (JP-A-11-210582) describes a fuel supply apparatus in which a load of a low pressure fuel pump is decreased by decreasing a set value for a low pressure regulator provided between the low pressure fuel pump and a high pressure fuel pump, when a discharge amount of the low pressure fuel pump is smaller than a fuel amount required by the high pressure fuel pump. In addition, Japanese Patent Application Publication No. 11-182371 (JP-A-11-182371) and Japanese Patent Application Publication No. 9-184460 (JP-A-9-184460) are related to the invention.

In each of the fuel supply apparatuses described in Japanese Patent Application Publication No. 2005-307931 (JP-A-2005-307931) and Japanese Patent Application Publication No. 11-210582 (JP-A-11-210582), the load of the low pressure fuel pump may be decreased by changing a feed pressure that is a fuel pressure between the low pressure fuel pump and the high pressure fuel pump, according to an operating state. However, in the apparatuses, because the low pressure fuel pump is constantly operated while the internal combustion engine is operating, electric power continues to be consumed by the low pressure fuel pump while the internal combustion engine is operating. Accordingly, the apparatuses need to be improved to further decrease the electric power consumed by the low pressure fuel pump.

### SUMMARY OF THE INVENTION

The invention provides a fuel supply apparatus and a fuel supply method for an internal combustion engine, which decrease electric power consumed by a low pressure fuel pump, as compared to the case where the low pressure fuel pump is constantly operated while the internal combustion engine is operating.

A first aspect of the invention relates to a fuel supply apparatus for an internal combustion engine. The fuel supply apparatus includes a high pressure fuel pump that is driven by an internal combustion engine, and that pressurizes fuel and supplies the fuel to the internal combustion engine; an electrically-operated low pressure fuel pump that delivers the fuel to the high pressure fuel pump; and a low pressure pump control portion that controls the low pressure fuel pump to avoid a discharge failure in the high pressure fuel pump due to insufficiency of a feed pressure at which the low pressure fuel pump delivers the fuel to the high pressure fuel pump. The low pressure pump control portion stops the low pressure fuel pump in a case where the discharge failure in the high pressure fuel pump is avoided even when the feed pressure is equal to a gauge pressure of 0.

In the fuel supply apparatus, the low pressure fuel pump is controlled to avoid a discharge failure in the high pressure fuel pump. Therefore, it is possible to decrease the feed pressure to a limit value at which a discharge failure in the high pressure fuel pump can be avoided. Accordingly, the electric power consumed by the low pressure fuel pump is decreased to a limit value, without causing a discharge failure in the high pressure fuel pump. Further, in the case where a discharge failure in the high pressure fuel pump is avoided even when the feed pressure of the low pressure fuel pump is equal to the gauge pressure of 0, the low pressure fuel pump is stopped. Therefore, it is possible to decrease the electric power consumed by the low pressure fuel pump, as compared to the case where the low pressure fuel pump is constantly operated while the internal combustion engine is operating.

The fuel supply apparatus in the above-described aspect of the invention may further include a feed pressure calculation portion that calculates a required feed pressure at which the discharge failure is avoided, based on a sum of a saturated vapor pressure of the fuel and pressure loss that occurs when the high pressure fuel pump sucks the fuel. The low pressure pump control portion may control the low pressure fuel pump so that the fuel is delivered to the high pressure fuel pump at the required feed pressure calculated by the feed pressure calculation portion.

A discharge failure is caused in the high pressure fuel pump when the fuel is boiled (vaporized) and vapor is generated in the high pressure fuel pump. The fuel is boiled when the pressure in the high pressure fuel pump is lower than a saturated vapor pressure corresponding to a fuel temperature. The pressure in the high pressure fuel pump is equivalent to a value obtained by subtracting the pressure loss that occurs when the high pressure fuel pump sucks the fuel, from the feed pressure at which the low pressure fuel pump delivers the fuel. According to the aspect, the required feed pressure, at which a discharge failure in the high pressure fuel pump is avoided, is calculated based on the sum of the saturated vapor pressure and the pressure loss. Therefore, for example, by making the required feed pressure equal to the sum of the saturated vapor pressure and 25 , the pressure loss, or making the required feed pressure equal to a value that is set to be larger than the sum, taking into account the variation of a fuel property and the variation of the pressure loss, it is possible to avoid a discharge failure in the high pressure fuel pump while suppressing the electric power consumed by the low pressure fuel pump.

In the aspect, the low pressure pump control portion may stop the low pressure fuel pump, when the required feed pressure calculated by the feed pressure calculation portion is equal to or lower than an atmospheric pressure. In this case, when the required feed pressure is equal to or lower than the atmospheric pressure, the low pressure fuel pump is stopped. Therefore, it is possible to further decrease a period in which the low pressure fuel pump is driven.

The high pressure fuel pump may be provided with an adjustment portion that adjusts a fuel pressure that is a pressure of the fuel supplied to the internal combustion engine. The fuel supply apparatus may further include a high pressure pump control portion that controls the adjustment portion by providing, for the adjustment portion, a controlled variable corresponding to a difference between an actual fuel pressure and a standard value of the fuel pressure so that the difference is decreased; and a feed pressure correction portion that corrects the required feed pressure calculated by the feed pressure-calculation portion, based on the controlled variable provided for the adjustment portion by the high pressure pump control portion.

The required feed pressure is calculated based on the sum of the saturated vapor pressure of the fuel and the pressure loss that occurs when the high pressure fuel pump sucks the fuel. However, there is a possibility that the required feed pressure may deviate from an appropriate value at which a discharge failure in the high pressure fuel pump is avoided, due to various factors such as a calculation error and the variation of the fuel property. If a discharge failure occurs in the high pressure fuel pump due to the deviation of the required feed pressure from an appropriate value, the fuel pressure downstream of the high pressure fuel pump deviates from the standard value due to the deviation of the required feed pressure from the appropriate value. As a result, the controlled variable provided for the adjustment portion is changed. According to the aspect, because the required feed pressure is corrected based on the controlled variable, it is possible to correct the required feed pressure without providing means for detecting the actual feed pressure, such as a pressure sensor. Therefore, it is possible to accurately control the low pressure fuel pump, without increasing the number of components.

The required feed pressure may be corrected in various methods. For example, when the controlled variable is equal to or larger than a predetermined value, the feed pressure correction portion may correct the required feed pressure to increase the required feed pressure. When the controlled variable is equal to or larger than the predetermined value, the fuel pressure downstream of the high pressure fuel pump is insufficient, and therefore, it is determined that the feed pressure deviates to an insufficient pressure. According to the aspect, when the controlled variable is equal to or larger than the predetermined value, the required feed pressure is corrected so that the required feed pressure is increased. Therefore, it is possible to eliminate the deviation of the feed pressure to an insufficient pressure. Also, the feed pressure correction portion may gradually correct the required feed pressure to gradually decrease the required feed pressure, on a condition that the controlled variable is maintained in a predetermined range. By performing the correction in this manner, the required feed pressure is made as low as possible, and therefore, the effect of decreasing the electric power consumed by the low pressure fuel pump is improved.

The corrected required feed pressure may be learned, and thereafter, the required feed pressure may be calculated using the corrected required feed pressure. For example, the fuel supply apparatus may further include a storage portion in which a feed pressure specifying portion is stored, wherein in the feed pressure specifying portion, values of the required feed pressure are set using, as parameters, an engine temperature that is a temperature of the internal combustion engine, and that is correlated with the saturated vapor pressure, and an engine speed that is correlated with the pressure loss; and a learning portion in which the required feed pressure corrected by the feed pressure correction portion is stored in association with the engine temperature and the engine speed. The learning portion may perform a learning process that modifies the value of the required feed pressure set in the feed pressure specifying portion, based on the corrected required feed pressure that is stored in association with the engine temperature and the engine speed. The feed pressure calculation portion may acquire the engine temperature and the engine speed, and may calculate the required feed pressure based on the acquired engine temperature and the acquired engine speed, using the feed pressure specifying portion.

The temperature characteristic of the saturated vapor pressure of the fuel changes according to the property of the fuel. For example, fuel manufacturers generally adjust fuel constituents in accordance with the season. In summer, generation of vapor is suppressed by adjusting the fuel constituents so that the saturated vapor pressure of the fuel is decreased to improve restartability at high temperature. In winter, the volatility of the fuel is increased by adjusting the fuel constituents so that the saturated vapor pressure of the fuel is increased to improve startability at low temperature. In this situation, in the case where the required feed pressure is calculated based on the feed pressure specifying portion, if the corresponding relation among the engine temperature correlated with the saturated vapor pressure of the fuel, the engine speed correlated with the pressure loss, and the required feed pressure is fixed, there is a possibility that a correction amount, by which the required feed pressure is corrected, may increase, and the control may become unstable. According to the aspect, by performing the learning process, the feed pressure specifying portion is modified using the corrected required feed pressure. Therefore, it is possible to suppress an increase in the correction amount by which the required feed pressure is corrected, and to improve performance of controlling the required feed pressure.

The feed pressure specifying portion will be described. Because the saturated vapor pressure is a physical amount that depends on the fuel temperature. Therefore, if the fuel temperature is given, the saturated vapor pressure of the fuel is uniquely determined. Because the fuel temperature can be regarded as being substantially equivalent to the engine temperature, for example, the coolant temperature and the temperature of lubricating oil, no .particular problem occurs if the engine temperature is regarded as the fuel temperature. Particularly because the fuel temperature hardly exceeds the engine temperature, when the engine temperature is regarded as the fuel temperature, a margin is provided to increase the degree of safety. The pressure loss of the high pressure fuel pump is inversely proportional to the area of an inlet of the pump, and is proportional to an inflow speed at which the fuel flows into the pump. The inflow speed, at which the fuel flows into the pump, is determined based on a drive speed at which the fuel pump is driven. Because the drive speed is proportional to the engine speed, and the area of the inlet of the pump is a fixed value, it is possible to calculate the pressure loss that occurs when the high pressure fuel pump sucks the fuel, by determining the drive speed based on the engine speed. Based on the above-described concept, in the feed pressure specifying portion, the engine temperature is used as the parameter for setting the required feed pressure, instead of the saturated vapor pressure, the engine speed is used as the parameter for setting the required feed pressure, instead of the pressure loss, and a corresponding relation between the engine temperature and the engine speed, and the required feed pressure is set. Thus, it is possible to calculate the required feed pressure based on the sum of the saturated vapor pressure and the pressure loss, by acquiring the engine temperature and the engine speed, and then, using the feed pressure specifying portion.

A condition for performing the learning process or a condition for stopping the learning process may be appropriately determined. For example, the fuel supply apparatus may further include a stop portion that stops the learning portion from performing the learning process, when the engine temperature changes to an extent larger than a first predetermined extent. For example, when the coolant temperature changes to a large extent, for example, during a period after the start of the internal combustion engine and before completion of warming-up, the degree of correlation between the engine temperature and the fuel temperature is decreased. Therefore, if the learning process is performed in this case, the learning process, which is not appropriate for the actual situation, may be performed. According to the aspect, when the engine temperature changes to a large extent, the learning process is stopped. Therefore, it is possible to avoid a problem that the learning process, which is not appropriate for the actual situation, is performed.

The fuel supply apparatus may further include a stop portion that stops the feed pressure correction portion from correcting the required feed pressure, and stops the learning portion from performing the learning process, when the engine speed changes to an extent larger than a second predetermined extent. When the engine speed changes to a large extent, for example, when the vehicle is accelerated or decelerated, the controlled variable provided for the adjustment portion changes to a large extent. Accordingly, in this case, there is a possibility that the correction performed based on the controlled variable may become unstable. According to the aspect, when the engine speed changes to an extent larger than the second predetermined extent, the correction of the required feed pressure and the learning process are prohibited. Therefore, it is possible to maintain appropriate accuracy of controlling the feed pressure.

In order to reduce emissions when the internal combustion engine is started, it may be required to quickly increase the fuel pressure downstream of the high pressure fuel pump, and to supply the fuel at the high fuel pressure when the internal combustion engine is started. This operation is generally referred to as “a start-time pressure increase operation”. The fuel supply apparatus may further include a start-time setting portion that sets a start-time feed pressure, at which the low pressure fuel pump delivers the fuel to the high pressure fuel pump when the internal combustion engine is started, to an upper limit value in a case where there is necessity of quickly increasing a fuel pressure provided by the high pressure fuel pump when the internal combustion engine is started, wherein the start-time setting portion sets the start-time feed pressure based on an engine temperature that is a temperature of the internal combustion engine, in a case where there is not the necessity. The low pressure pump control portion may control the low pressure fuel pump so that the fuel is delivered to the high pressure fuel pump at the start-time feed pressure set by the start-time setting portion when the internal combustion engine is started. Thus, the fuel pressure is quickly increased when the internal combustion engine is started. Therefore, emissions are reduced when the internal combustion engine is started.

In the case where there is not the necessity of quickly increasing the fuel pressure when the internal combustion engine is started, the start-time feed pressure is set based on the engine temperature. For example, in the case where there is not the necessity, the start-time setting portion may set the start-time feed pressure so that when the engine temperature is higher than an upper limit value of an ordinary temperature region, the start-time feed pressure increases as the engine temperature increases, and when the engine temperature is lower than a lower limit value of the ordinary temperature region, the start-time feed pressure increases as the engine temperature decreases.

According to the aspect, when the engine temperature is lower than the lower limit value of the ordinary temperature region, the start-time feed pressure is set, to a high value. Therefore, it is possible to sufficiently promote gasification of the fuel, and to ensure a sufficient flow rate. Also, when the engine temperature is higher than the upper limit value of the ordinary temperature region, the start-time feed pressure is set to a high value. Therefore, it is possible to suppress generation of vapor of the fuel. The start-time setting portion may set the start-time feed pressure to a constant value when the engine temperature is in the ordinary temperature region.

As described above, in the fuel supply apparatus according to the above-described aspect of the invention, the low pressure fuel pump is controlled to avoid a discharge failure in the high pressure fuel pump. Therefore, it is possible to decrease the feed pressure to a limit value at which a discharge failure in the high pressure fuel pump can be avoided. Accordingly, the electric power consumed by the low pressure fuel pump is decreased to a limit value, without causing a discharge failure in the high pressure fuel pump. Further, in the case where a discharge failure in the high pressure fuel pump is avoided even when the feed pressure of the low pressure fuel pump is equal to the gauge pressure of 0, the low pressure fuel pump is stopped. Therefore, it is possible to decrease the electric power consumed by the low pressure fuel pump, as compared to the case where the low pressure fuel pump is constantly operated while the internal combustion engine is operated.

A second aspect of the invention relates to a fuel supply method for an internal combustion engine, in which fuel is delivered to a high pressure fuel pump driven by an internal combustion engine, using an electrically-operated low pressure fuel pump, and the fuel pressurized by the high pressure fuel pump is supplied to the internal combustion engine. The fuel supply method includes calculating a required feed pressure at which a discharge failure in the high pressure fuel pump due to insufficiency of a feed pressure is avoided, based on a sum of a saturated vapor pressure of the fuel and pressure loss that occurs when the high pressure fuel pump sucks the fuel, wherein the feed pressure is a pressure at which the low pressure fuel pump delivers the fuel to the high pressure fuel pump; controlling the low pressure fuel pump so that the fuel is delivered to the high pressure fuel pump at the required feed pressure that is calculated; and stopping the low pressure fuel pump in a case where the discharge failure in the high pressure fuel pump is avoided even when the feed pressure is equal to a gauge pressure of 0.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a diagram schematically showing a fuel supply system for an internal combustion engine, to which a fuel supply apparatus according to a first embodiment of the invention is applied;

FIG. 2 is a functional block diagram showing a control system of the fuel supply apparatus shown in FIG. 1;

FIG. 3 is a diagram showing a relation between a saturated vapor pressure of fuel and a required feed pressure in the first embodiment;

FIG. 4 is a functional block diagram showing a control system of a fuel supply apparatus according to a second embodiment;

FIG. 5 is a flowchart showing an example of a control routine according to a third embodiment;

FIG. 6 is a flowchart showing a start-time control routine defined as a sub routine in FIG. 5; and

FIG. 7 is a flowchart showing an example of a start-time feed pressure calculation map in the third embodiment.

### DETAILED DESCRIPTION OF EMBODIMENTS

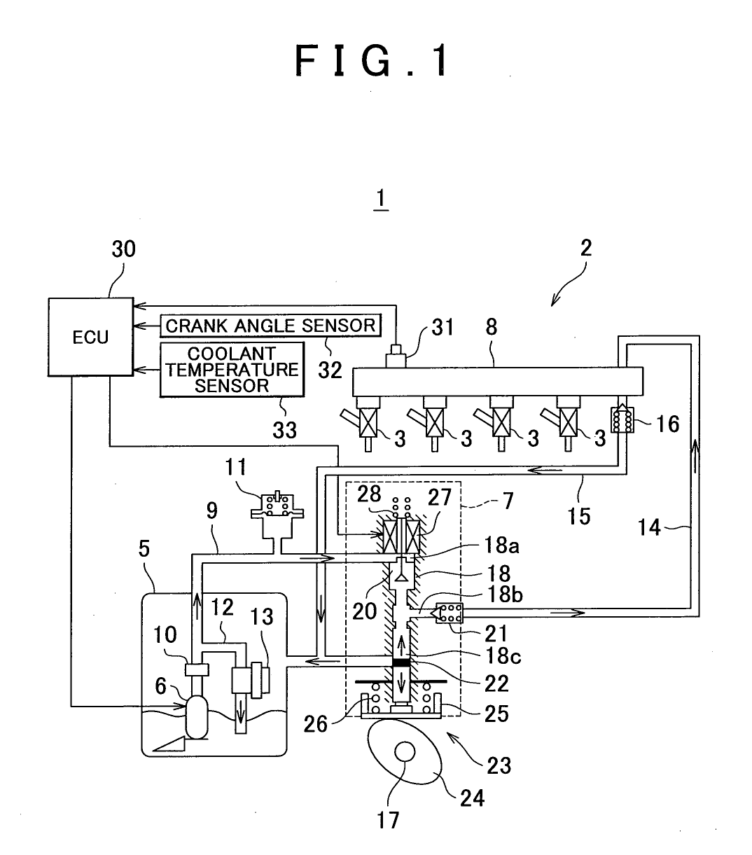

FIG. 1 is a diagram schematically showing a fuel supply system for an internal combustion engine, to which a fuel supply apparatus according to a first embodiment of the invention is applied. An internal combustion engine 1 is provided in a vehicle (not shown) as a power source for driving the vehicle. The internal combustion engine 1 is an in-line four cylinder direct-injection spark-ignition internal combustion engine. The fuel supply apparatus 2 includes fuel injection valves 3 for respective cylinders of the internal combustion engine 1. Each fuel injection valve 3 is attached to a cylinder head (not shown) so that an end of the fuel injection valve 3 is directed into the corresponding cylinder.

The fuel supply apparatus 2 includes a low pressure fuel pump 6, a high pressure fuel pump 7, and a delivery pipe 8 so that each fuel injection valve 3 supplies fuel. The low pressure fuel pump 6 pumps up the fuel from a fuel tank 5 in which gasoline, which is the fuel, is stored. The high pressure fuel pump 7 that increases the pressure of the fuel to be supplied into the cylinders (i.e., fuel pressure). The delivery pipe 8 distributes the fuel discharged from the high pressure fuel pump 7 to the fuel injection valves 3. The fuel is delivered to the high pressure fuel pump 7 using the low pressure fuel pump 6. The fuel pressurized by the high pressure fuel pump 7 is distributed to the cylinders of the internal combustion engine 1 through the delivery pipe 8.

The low pressure fuel pump 6 is connected to the high pressure fuel pump 7 by a low pressure passage 9. The low pressure passage 9 is provided with a filter 10 and a pulsation damper 11. The filter 10 filters the fuel. The pulsation damper 11 dampens pulsations of the fuel caused by driving the pumps. A branch passage 12 is connected to the low pressure passage 9 at a position downstream of the low pressure fuel pump 6. A pressure regulator 13 is provided in the branch passage 12. The pressure regulator 13 prevents a pressure in the low pressure passage 9 from exceeding a predetermined upper limit value. The high pressure fuel pump 7 is connected to the delivery pipe 8 by a high pressure passage 14.

A return passage 15 is connected to the delivery pipe 8. Excess fuel is returned to the fuel tank 5 through the return passage 15. The return passage 15 is provided with a relief valve 16. When the fuel pressure exceeds an upper limit value, the relief valve 16 opens the return passage 15. Accordingly, the excess fuel is returned to the fuel tank 5. The return passage 15 is also connected to the high pressure fuel pump 7. Therefore, excess fuel in the high pressure fuel pump 7 is also returned to the fuel tank 5 through the return passage 15.

The low pressure fuel pump 6 is provided in the fuel tank 5. Although the inner structure of the low pressure fuel pump 6 is not shown, the low pressure fuel pump 6 is a known rotary electric pump that includes a direct-current electric motor and an impeller driven by the motor.

The high pressure fuel pump 7 is a known plunger pump that is driven by power taken from a camshaft 17 of the internal combustion engine 1. The high pressure fuel pump 7 includes an inlet port 18a and a discharge port 18b that are formed in a pump housing 18. The low pressure passage 9 is connected to the inlet port 18a. The high pressure passage 14 is connected to the discharge port 18b. A plunger chamber 18c is formed in the pump housing 18. A plunger 22 reciprocates in the plunger chamber 18c.

Communication is provided between the plunger chamber 18c and each of the inlet port 18a and the discharge port 18b. An electromagnetically-driven inlet valve 20 is provided in the inlet port 18a. A check valve 21 is provided in the discharge port 18b. The check valve 21 prevents backflow of the fuel. A plunger drive device 23 is provided in the high pressure fuel pump 7. The plunger drive device 23 converts the rotation of the camshaft 17 to the reciprocating movement of the plunger 22. The plunger drive device 23 includes a pump drive cam 24 formed in the camshaft 17; a cam follower 25 connected to the plunger 22; and a return spring 26 that presses the pump drive cam 24 to the cam follower 25.

In the high pressure fuel pump 7, when the camshaft 17 is rotated by operation of the internal combustion engine 1, the plunger 22 reciprocates in the plunger chamber 18c. The opening/closing of the inlet valve 20 is controlled in accordance with the reciprocating movement of the plunger 22. Thus, the discharge amount of the fuel is adjusted. The inlet valve 20 is driven by a solenoid 27. A valve-opening spring 28 is fitted to the inlet valve 20 so that the inlet port 18a is opened when supply of electric power to the solenoid 27 is stopped. The fuel pressure downstream of the high pressure fuel pump 7 is changed, by increasing/decreasing a closed period in which the inlet valve 20 is closed during a compression stroke of the high pressure fuel pump 7. Accordingly, the inlet valve 20 in FIG. 1 may be regarded as the adjustment portion according to the invention.

The operation of each of the low pressure fuel pump 6 and the high pressure fuel pump 7 is controlled by an engine control unit (ECU) 30. As well known, the ECU 30 is configured as a computer that acquires information output from sensors, calculates operation parameters such as a fuel injection amount and an ignition timing, and operates devices to be controlled, such as each fuel injection valve 3 and an ignition plug (not shown). Although not shown in the drawings, the ECU 30 includes a microprocessor that functions as a main processing device, and peripheral devices (for example, a storage device) that are required for the operation of the microprocessor. Because the ECU 30 is connected to various sensors, only sensors related to the invention are shown in the drawings. The sensors related to the invention include a fuel pressure sensor 31 that outputs a signal corresponding to the pressure (fuel pressure) in the delivery pipe 8; a crank angle sensor 32 that outputs a signal corresponding to the rotational speed of the internal combustion engine 1 (i.e., an engine speed); and a coolant sensor 33 that outputs a signal corresponding to the temperature of a coolant that circulates in the internal combustion engine 1.

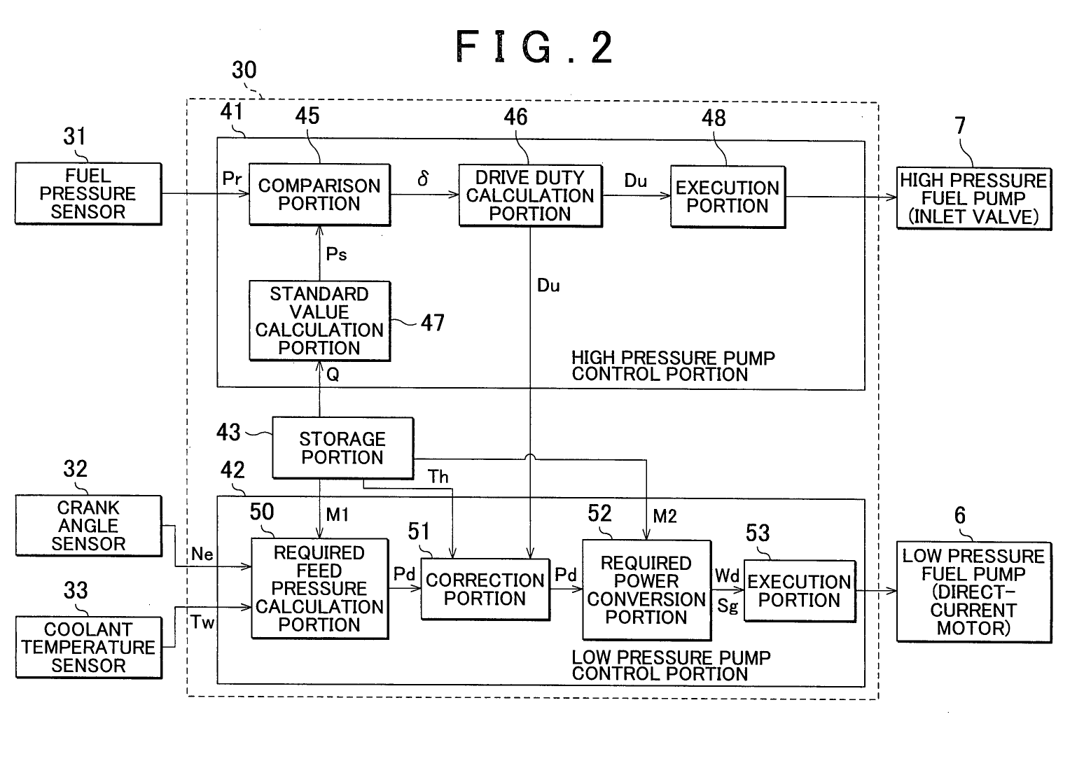

FIG. 2 is a functional block diagram showing a control system of the fuel supply apparatus 2. As shown in FIG. 2, the ECU 30 includes a high pressure pump control portion 41 that controls the high pressure fuel pump 7; a low pressure pump control portion 42 that controls the low pressure fuel pump 6; and a storage portion 43 from which information used by the control portions 41 and 42 is read out, and in which the information used by the control portions 41 and 42 is written.

The high pressure pump control portion 41 acquires an actual fuel pressure Pr from the fuel pressure sensor 31. In the high pressure pump control portion 41, a comparison portion 45 calculates a difference δ between the fuel pressure Pr and a standard value Ps, and transmits the difference δ to a drive duty calculation portion 46. A standard value calculation portion 47 calculates the standard value Ps of the fuel pressure. The standard value calculation portion 47 reads out a current fuel injection amount Q stored in the storage portion 43, and calculates the standard value Ps based on the fuel injection amount Q. The fuel injection amount Q is separately calculated based on physical amounts such as the engine speed and a load factor. The drive duty calculation portion 46 calculates a drive duty Du that is a controlled variable corresponding to the difference δ. Then, the drive duty calculation portion 46 transmits the drive duty Du to each of an execution portion 48 and the low pressure pump control portion 42. The execution portion 48 supplies electric power to the solenoid 27 of the inlet valve 20. Thus, (the inlet valve 20 of) the high pressure fuel pump 7 is controlled so that the difference δ is decreased. As a result, the fuel pressure is changed to the standard value corresponding to an operating state.

The low pressure pump control portion 42 acquires an engine speed Ne from the crank angle sensor 32, and acquires a coolant temperature Tw from the coolant temperature sensor 33. A required feed pressure calculation portion 50 of the low pressure pump control portion 42 calculates a required feed pressure Pd based on the engine speed Ne and the coolant temperature Tw. The required feed pressure calculation portion 50 transmits the required feed pressure Pd to a correction portion 51. The required feed pressure calculation portion 50 calculates the required feed pressure Pd so that the required feed pressure Pd is a value at which a discharge failure in the high pressure fuel pump 7 is avoided. The required feed pressure calculation portion 50 reads out a feed pressure calculation map M1 stored in the storage portion 43, and calculates the required feed pressure Pd using the map M1 . Although the data structure of the map M1 is not shown in the drawings, in the feed pressure calculation map M 1, values of the required feed pressure Pd are set using the coolant temperature Tw and the engine speed Ne as parameters. A discharge failure is caused in the high pressure fuel pump 7 when the fuel is boiled and vapor is generated in the high pressure fuel pump 7 (i.e., in the plunger chamber 18c). The fuel is boiled when the pressure in the high pressure fuel pump 7 is lower than a saturated vapor pressure corresponding to a fuel temperature.

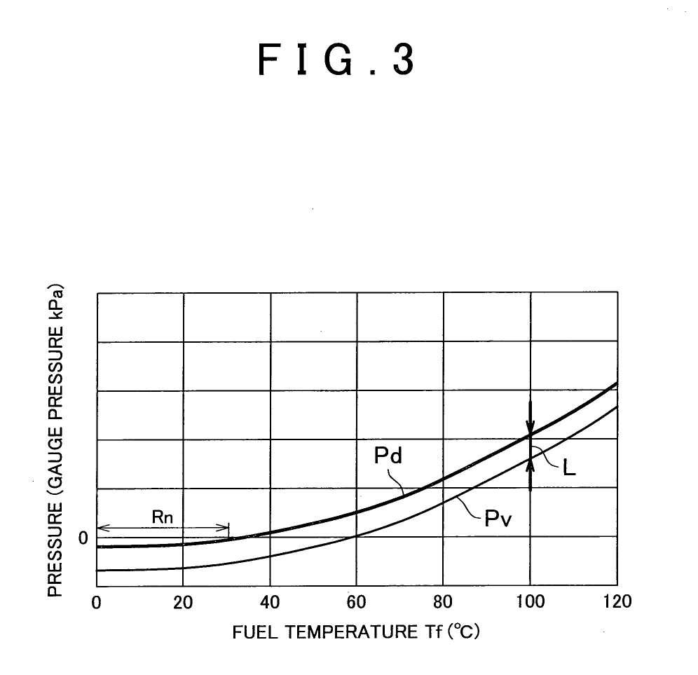

FIG. 3 is a diagram showing a line indicating the saturated vapor pressure of the fuel, and a line indicating the required feed pressure Pd calculated by the required feed pressure calculation portion 50. That is, FIG. 3 shows a relation between a saturated vapor pressure Pv of the fuel and the required feed pressure Pd. As shown in FIG. 3, the required feed pressure Pd changes with respect to a fuel temperature Tf along the line indicating the saturated vapor pressure Pv of the fuel, that is, the required feed pressure Pd changes with respect to the fuel temperature Tf in a manner similar to a manner in which the saturated vapor pressure Pv changes. The required feed pressure Pd is higher than the saturated vapor pressure Pv at each value of the fuel temperature Tf. A difference between the required feed pressure Pd and the saturated vapor pressure Pv is equivalent to pressure loss L that occurs when the high pressure fuel pump 7 sucks the fuel. The pressure in the high pressure fuel pump 7 is equivalent to a value obtained by subtracting the pressure loss that occurs when the high pressure fuel pump 7 sucks the fuel, from the feed pressure at which the low pressure fuel pump 6 delivers the fuel to the high pressure fuel pump 7. Accordingly, when the fuel is delivered to the high pressure fuel pump 7 at the required feed pressure Pd shown in FIG. 3, the pressure in the high pressure fuel pump 7 does not become lower than the saturated vapor pressure Pv. Therefore, the fuel is not boiled, and vapor is not generated in the plunger chamber 18c of the high pressure fuel pump 7. Thus, it is possible to avoid a discharge failure in the high pressure fuel pump 7. As shown in FIG. 3, the required feed pressure Pd may become lower than the atmospheric pressure. That is, in the feed pressure calculation map M1, negative gauge pressure values are also set as the values of the required feed pressures Pd. In a range Rn in which the values of the required feed pressure Pd are set to the negative gauge pressure values, even when the actual feed pressure is equal to the gauge pressure of 0, it is possible to avoid a discharge failure in the high pressure fuel pump 7.

The saturated vapor pressure is a physical amount that depends on the fuel temperature. Therefore, if the fuel temperature is given, the saturated vapor pressure is uniquely determined Because the fuel temperature can be regarded as being substantially equivalent to the coolant temperature, no particular problem occurs when the coolant temperature is regarded as the fuel temperature. Particularly because the fuel temperature hardly exceeds the coolant temperature, when the coolant temperature is regarded as the fuel temperature, a margin is provided to increase the degree of safety. The pressure loss of the high pressure fuel pump 7 is inversely proportional to the area of the inlet of the pump, and is proportional to an inflow speed at which the fuel flows into the pump. The inflow speed, at which the fuel flows into the pump, is determined based on a drive speed at which the fuel pump is driven. Because the drive speed is proportional to the engine speed, and the area of the inlet of the pump is a fixed value, it is possible to calculate the pressure loss that occurs when the high pressure fuel pump 7 sucks the fuel, by determining the drive speed based on the engine speed. Thus, the coolant temperature Tw is correlated with the saturated vapor pressure Pv of the fuel, and the engine speed Ne is correlated with the pressure loss that occurs when then high pressure fuel pump 7 sucks the fuel. Accordingly, in the feed pressure calculation map M1, the coolant temperature Tw is used as the parameter for setting the required feed pressure Pd, instead of the saturated vapor pressure Pv, the engine speed Ne is used as the parameter for setting the required feed pressure Pd, instead of the pressure loss L, and a corresponding relation between the coolant temperature Tw and the engine speed Ne, and the required feed pressure Pd is set. The corresponding relation between the physical amounts described in the feed pressure calculation map M1 may be empirically determined using an actual machine, or may be determined through simulation using a predetermined calculation model. More specifically, in the feed pressure calculation map M1, the required feed pressure Pd is set to a value equal to the sum of the saturated vapor pressure Pv and the pressure loss L (refer to FIG. 3). Thus, it is possible to avoid a discharge failure in the high pressure fuel pump 7 while suppressing electric power consumed by the low pressure fuel pump 6. In the feed pressure calculation map M1, the required feed pressure Pd may be set to a value larger than the sum of the saturated vapor pressure Pv and the pressure loss L by several %, taking into account the variation of a fuel property, and the variation of the pressure loss.

As shown in FIG. 2, the correction portion 51 compares the drive duty Du received from the high pressure pump control portion 41, and a predetermined value Th stored in the storage portion 43. When the drive duty Du is equal to or larger than the predetermined value Th, the correction portion 51 corrects the required feed pressure Pd to increase the required feed pressure Pd, and transmits the corrected required feed pressure Pd, to a required power conversion portion 52. The predetermined value Th is defined as a function of the fuel injection amount Q. As described above, the required feed pressure calculation portion 50 calculates the required feed pressure Pd based on the feed pressure calculation map M1. However, there is a possibility that the required feed pressure Pd may deviate from an appropriate value at which a discharge failure in the high pressure fuel pump 7 is avoided, due to various factors such as a calculation error and the variation of the fuel property. If a discharge failure occurs in the high pressure fuel pump 7 due to the deviation of the required feed pressure Pd from the appropriate value, the fuel pressure downstream of the high pressure fuel pump 7 deviates from the standard value Ps of the fuel pressure due to the deviation of the required feed pressure Pd from the appropriate value. As a result, the drive duty Du provided for the solenoid 27 of the inlet value 120 is changed. When the drive duty Du is increased, the fuel pressure is insufficient, and therefore, it is determined that the required feed pressure Pd deviates from the appropriate value to an insufficient pressure.

The correction portion 51 evaluates the degree of increase in the drive duty Du using the predetermined value Th. When the drive duty Du is equal to or larger than the predetermined value Th, the correction portion 51 corrects the required feed pressure Pd to increase the required feed pressure Pd. Therefore, it is possible to eliminate the deviation of the required feed pressure Pd to an insufficient pressure. Thus, the required feed pressure Pd is returned to the appropriate value before it becomes evident that a discharge failure occurs in the high pressure fuel pump 7. When the drive duty Du is smaller than the predetermined value Th, there is no possibility that a discharge failure occurs in the high pressure fuel pump 7. Therefore, the correction portion 51 does not correct the required feed pressure Pd, and transmits the uncorrected required feed pressure Pd to the required power conversion portion 52. Thus, because the required feed pressure Pd is corrected based on the drive duty Du of the high pressure fuel pump 7, it is possible to correct the required feed pressure Pd without providing means for detecting the actual feed pressure, such as a pressure sensor. Thus, it is possible to accurately control the low pressure fuel pump 6, without increasing the number of components. The correction portion 51 may perform correction in a manner different from the above-described manner. That is, the correction portion 51 may gradually correct the required feed pressure Pd to gradually decrease the required feed pressure Pd on the condition that the drive duty Du is maintained in a predetermined range stored in advance in the storage portion 43. By performing this correction, the required feed pressure Pd is made as low as possible, and therefore, electric power consumed by the low pressure fuel pump 6 is decreased. The correction portion 51 may perform this correction simultaneously with the above-described correction.

The required power conversion portion 52 converts the required feed pressure Pd transmitted from the correction portion 51, to required electric power Wd. Then, the required power conversion portion 52 transmits the required electric power Wd to the execution portion 53. The required electric power Wd is a value of electric power that needs to be supplied to enable the low pressure fuel pump 6 to deliver the fuel at the required feed pressure Pd. The required power conversion portion 52 reads out a conversion map M2 that is retained in advance in the storage portion 43. In the conversion map M2, values of the required electric power Wd are set using the required feed pressure Pd as a parameter. The required power conversion portion 52 converts the required feed pressure Pd to the required electric power Wd by searching the conversion map M2. When the required feed pressure Pd is equal to or lower than the gauge pressure of 0, the required power conversion portion 52 does not convert the required electric power Wd, and transmits a pump stop signal Sg to the execution portion 53.

The execution portion 53 supplies electric power equivalent to the required electric power Wd, to (the direct-current motor of) the low pressure fuel pump 6. Thus, the low pressure fuel pump 6 is driven, and the required feed pressure Pd is achieved. Also, when the execution portion 53 receives the stop signal Sg from the required power conversion portion 52, the execution portion 53 stops supplying the electric power to the low pressure fuel pump 6, thereby stopping the low pressure fuel pump 6. Thus, when the required feed pressure Pd is equal to or lower than the atmospheric pressure, the low pressure fuel pump 6 is stopped. This decreases a period in which the low pressure fuel pump 6 is driven.

According to the embodiment, the low pressure pump control portion 42 of the ECU 30 controls the low pressure fuel pump 6 to avoid a discharge failure in the high pressure fuel pump 7. Therefore, it is possible to decrease the feed pressure to a limit value at which a discharge failure in the high pressure fuel pump 7 can be avoided. Accordingly, the electric power consumed by the low pressure fuel pump 6 is decreased to a limit value, without causing a discharge failure in the high pressure fuel pump 7.

Further, in the case where a discharge failure in the high pressure fuel pump 7 is avoided even when the feed pressure of the low pressure fuel pump 6 is equal to the gauge pressure of 0, the low pressure fuel pump 6 is stopped. Therefore, it is possible to decrease the electric power consumed by the low pressure fuel pump 6, as compared to the case where the low pressure fuel pump 6 is constantly operated while the internal combustion engine 1 is operating.

In the embodiment, the low pressure pump control portion 42 of the ECU 30 may be regarded as the low pressure pump control portion according to the invention; the high pressure pump control portion 41 may be regarded as the high pressure pump control portion according to the invention; the require feed pressure calculation portion 50 may be regarded as the feed pressure calculation portion according to the invention; and the correction portion 51 may be regarded as the feed pressure correction portion according to the invention.

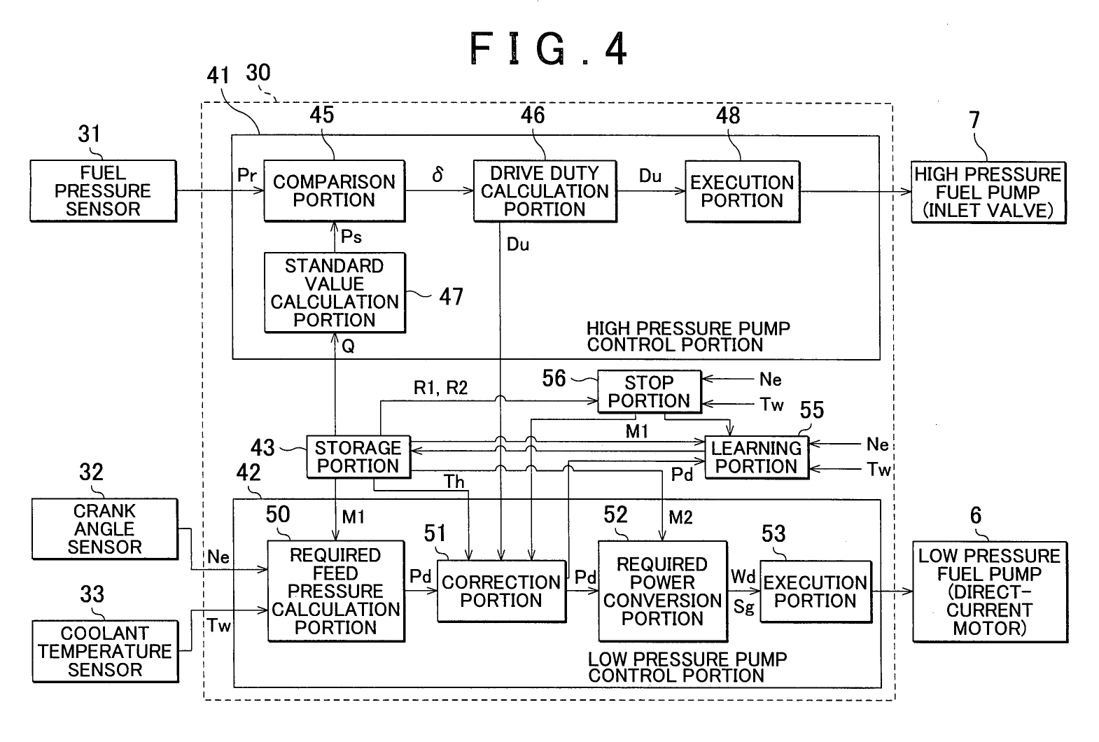

Next, a fuel supply apparatus according to a second embodiment of the invention will be described with reference to FIG. 4. The physical configuration in the second embodiment is the same as that in the first embodiment, and therefore, the redundant description thereof will be omitted. In the second embodiment, after the required feed pressure is corrected, a learning process is performed to modify the content of the feed pressure calculation map M1. FIG. 4 is a functional block diagram showing a control system of the fuel supply apparatus 2 according to the second embodiment. In FIG. 4, the same and corresponding portions as those in the first embodiment are denoted by the same reference numerals. Unless otherwise specified, portions denoted by the same references numeral as those in the first embodiment have the same functions as those in the first embodiment.

As shown in FIG. 4, the ECU 30 includes a learning portion 55 that modifies the feed pressure calculation map M1 using the corrected feed pressure Pd. The correction portion 51 in the embodiment transmits the corrected required feed pressure Pd to the required power conversion portion 52, and to the learning portion 55. In the learning portion 55, the required feed pressure Pd acquired from the correction portion 51 is stored in association with the engine speed Ne acquired from the crank angle sensor 32 and the coolant temperature Tw acquired from the coolant temperature sensor 33. Also, the learning portion 55 reads out the feed pressure calculation map M1 from the storage portion 43, and searches the feed pressure calculation map M1 based on the engine speed Ne and the coolant temperature Tw that are stored in the learning portion 55. Then, the learning portion 55 rewrites the required feed pressure Pd acquired by the search, to the corrected required feed pressure Pd. Thus, the content of the feed pressure calculation map M1 is modified. Then, the learning portion 55 stores the modified feed pressure calculation map M1 in the storage portion 43. The learning portion 55 functions as the learning portion according to the invention, by performing the learning process. Because the feed pressure calculation map M1 is thus modified using the corrected required feed pressure Pd, it is possible to suppress an increase in a correction amount by which the required feed pressure Pd is corrected by the correction portion 51. This improves control performance. If the learning process is not performed, there is a possibility that the correction portion 51, may not be able to appropriately perform the correction in accordance with a change in the fuel property, or the correction amount may increase, and thus, the control may be unstable. For example, fuel manufacturers generally adjust fuel constituents in accordance with the season. For example, in summer, generation of vapor is suppressed by adjusting the fuel constituents so that the saturated vapor pressure is decreased to improve restartability at high temperature. In winter, the volatility of the fuel is increased by adjusting the fuel constituents so that the saturated vapor pressure is increased to improve startability at low temperature. The learning process performed by the learning portion 55 makes it possible to appropriately perform the control in this situation.

The ECU 30 further includes a stop portion 56 that stops at least one of the correction of the required feed pressure Pd performed by the correction portion 51, and the learning process performed by the learning portion 55. When the coolant temperature Tw changes to a large extent, for example, during a period after the start of the internal combustion engine 1 and before completion of warming-up, the degree of correlation between the coolant temperature Tw and the fuel temperature is decreased. Therefore, if the learning process is performed in this case, the learning process, which is not appropriate for the actual situation, may be performed. Thus, the stop portion 56 acquires the coolant temperature Tw from the coolant temperature sensor 33. When the coolant temperature Tw changes to an extent larger than a predetermined extent R1 read out from the storage portion 43, the stop portion 56 transmits a stop command to the learning portion 55. The learning portion 55, which receives the stop command, stops performing the above-described learning process immediately. Thus, when the coolant temperature Tw changes to a large extent, the learning process is stopped. Therefore, it is possible to avoid a problem that the learning process, which is not appropriate for the actual situation, is performed.

Also, when the engine speed Ne changes to a large extent, for example, when the vehicle is accelerated or decelerated, the drive duty Du provided for the inlet valve 20 of the high pressure fuel pump 7 changes to a large extent. Accordingly, in this case, there is a possibility that the correction performed by the correction portion 51 based on the drive duty Du may become unstable. Thus, the stop portion 56 acquires the engine speed Ne from the crank angle sensor 32. When the engine speed Ne changes to an extent larger than a predetermined extent R2 read out from the storage portion 43, the stop portion 56 transmits the stop command to the correction portion 51 and to the learning portion 55. The correction portion 51, which receives the stop command, immediately stops performing the correction of the required feed pressure Pd, and the learning portion 55, which receives the stop command, immediately stops performing the learning process. Thus, when the engine speed Ne changes to a large extent, the correction of the required feed pressure Pd and the learning process are prohibited. Therefore, it is possible to maintain appropriate accuracy of controlling the feed pressure.

In the embodiment, the feed pressure calculation map M1 may be regarded as the feed pressure specifying portion according to the invention. The storage portion 43, in which the feed pressure calculation map M1 is stored, may be regarded as the storage portion according to the invention. The learning portion 55 of the ECU 30 may be regarded as the learning portion according to the invention. The stop portion 56 may be regarded as the stop portion according to the invention.

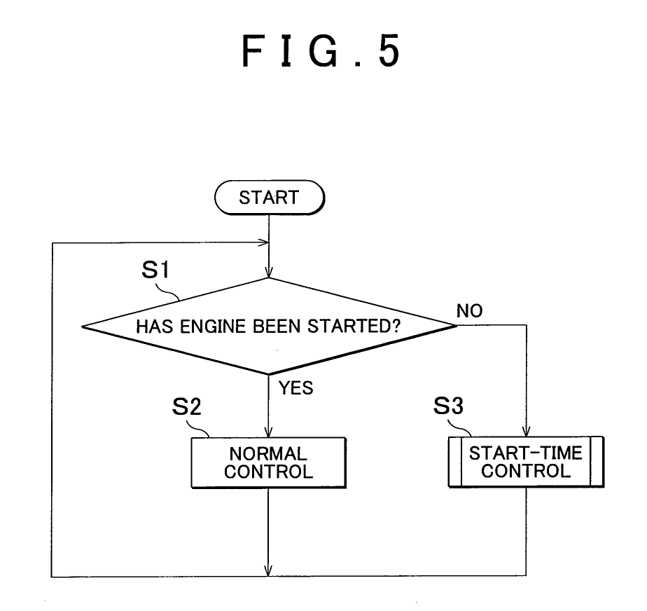

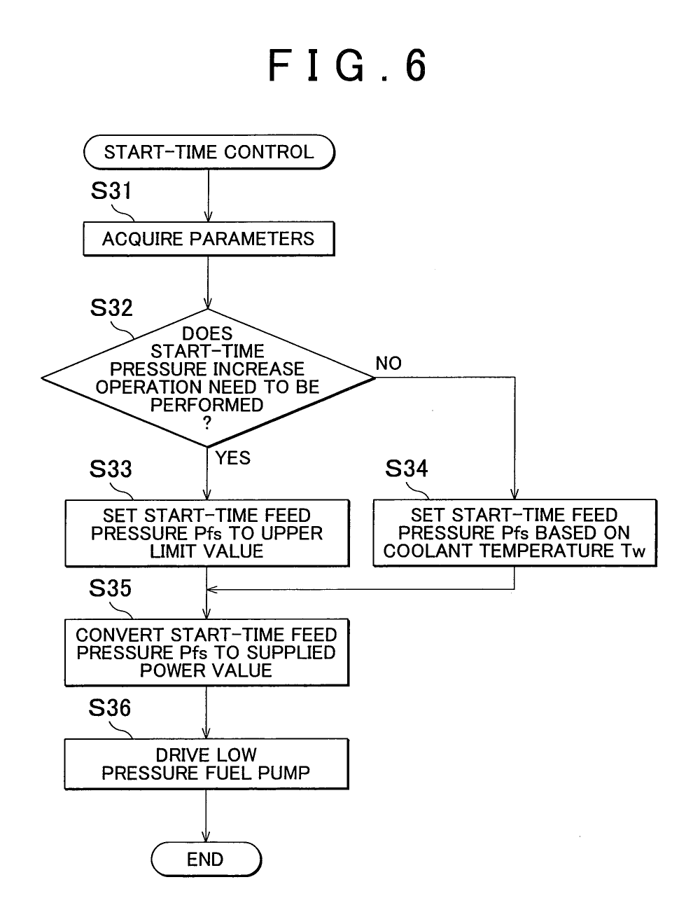

Next, a fuel supply apparatus according to a third embodiment of the invention will be described with reference to FIG. 5 to FIG. 7. The physical configuration in the third embodiment is the same as that in the first embodiment, and therefore, the redundant description thereof will be omitted. In the third embodiment, the content of the control at the time of start of the internal combustion engine 1 is different from the content of the control after the internal combustion engine 1 is started. FIG. 5 is a flowchart showing an example of a control routine according to the third embodiment, which is executed by the low pressure pump control portion 42 of the ECU 30. FIG. 6 is a start-time control routine defined as a sub routine in FIG. 5.

As shown in FIG. 5, in step S1, it is determined whether the internal combustion engine 1 has been started. It is determined whether the internal combustion engine 1 has been started, by acquiring the engine speed Ne from the crank angle sensor 32, and determining whether the engine speed Ne has exceeded a predetermined start determination threshold value. If it is determined that the internal combustion engine 1 has been started, the routine proceeds to step S2, and a normal control is executed. If it is determined that the internal combustion engine 1 has not been started, that is, the internal combustion engine 1 is being started, the routine proceeds to step S3, and the start-time control is executed. The normal control executed in step S2 is the above-described control according to the first or second embodiment (refer to FIG. 2 and FIG. 4).

In the start-time control in FIG. 6, first, in step S31, parameters are acquired. The acquired parameters include a coolant temperature and a catalyst temperature of an exhaust system, which influence the determination as to whether a start-time pressure increase operation needs to be performed. The start-time pressure increase operation is a known operation that quickly increases the fuel pressure downstream of the high pressure fuel pump, and supplies the fuel at a high fuel pressure when the internal combustion engine 1 is started, to reduce emissions at the time of start of the internal combustion engine 1. Subsequently, in step S32, it is determined whether the start-time pressure increase operation needs to be performed, based on the acquired parameters. If the start-time pressure increase operation needs to be performed, the routine proceeds to step S33. If the start-time pressure increase operation does not need to be performed, the routine proceeds to step S34.

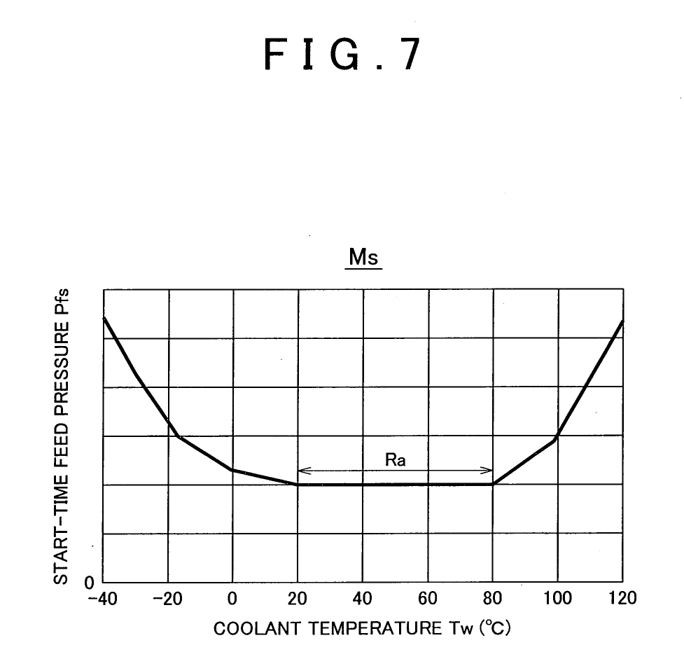

In step S33, a start-time feed pressure Pfs is set to an upper limit value. The start-time feed pressure Pfs is a feed pressure at which the low pressure fuel pump 6 delivers the fuel to the high pressure fuel pump 7 when the internal combustion engine 1 is started. The upper limit value corresponds to a limit of the capability of the low pressure fuel pump 6. In step S34, the start-time feed pressure Pfs is set based on the coolant temperature Tw. The start-time feed pressure Pfs is set by searching a start-time feed pressure calculation map Ms in FIG. 7, which is retained in the ECU 30. As shown in FIG. 7, in the calculation map Ms, values of the start-time feed pressure Pfs are set using the coolant temperature Tw as a parameter. In the map Ms, the start-time feed pressure Pfs is set so that when the coolant temperature Tw is higher than an upper limit value of an ordinary temperature region Ra, the start-time feed pressure Pfs increases as the coolant temperature Tw increases, and when the coolant temperature Tw is lower than a lower limit value of the ordinary temperature region Ra, the start-time feed pressure Pfs increases as the coolant temperature Tw decreases. In the ordinary temperature region Ra, the start-time feed pressure Pfs is set to a constant value. Thus, when the coolant temperature Tw is lower than the lower limit value of the ordinary temperature region Ra, the start-time feed pressure Pfs is set to a high value. Therefore, it is possible to sufficiently promote the gasification of the fuel, and to ensure a sufficient flow rate. Also, when the coolant temperature Tw is higher than the upper limit value of the ordinary temperature region Ra, the start-time feed pressure is set to a high value. Therefore, it is possible to suppress generation of vapor of the fuel.

In step S35, the start-time feed pressure Pfs set in step S33 or step S34 is converted to a supplied power value that is a value of electric power to be supplied to the low pressure fuel pump 6. Subsequently, in step S36, the electric power equivalent to the supplied power value is supplied to (the direct-current motor of) the low pressure fuel pump 6, and thus, the necessary start-time feed pressure Pfs is ensured.

According to the third embodiment, if the start-time pressure increase operation needs to be performed, it is possible to quickly increase the fuel pressure when the internal combustion engine 1 is started. Therefore, it is possible to reduce emissions when the internal combustion engine 1 is started. In the third embodiment, when the ECU 30 executes the control routine shown in FIG. 6, the ECU 30 functions as the start-time setting portion according to the invention, and the low pressure pump control portion according to the invention.

The invention is not limited to the above-described embodiments, and the invention may be realized in various embodiments. In the above-described embodiments, it is assumed that the fuel is supplied to the internal combustion engine. However, if the fuel supply is stopped, for example, if the delivery of the fuel to the fuel injection valve by the high pressure fuel pump is stopped when fuel injection is stopped at the time of deceleration, or when the fuel pressure is decreased, the low pressure fuel pump may be stopped, because it is not necessary to deliver the fuel to the high pressure fuel pump using the low pressure fuel pump. This suppresses unnecessary consumption of electric power.

In the above-described embodiments, the required feed pressure Pd is corrected based on the drive duty Du of the high pressure fuel pump 7. However, the invention is not limited to the embodiments. For example, a pressure sensor may be provided in a low pressure passage, an actual feed pressure may be detected using the sensor, and the required feed pressure Pd may be corrected through feedback so that a difference between the actual feed pressure and a target value is decreased.

In the above-described embodiments, after the required feed pressure Pd is calculated or corrected, the pressure value is converted to the value of the electric power to be supplied to the low pressure fuel pump 6. However, the invention is not limited to the embodiments. For example, a map, in which a supplied power value that makes the feed pressure equal to the appropriate required feed pressure Pd is set using parameters such as the engine speed Ne and the coolant temperature Tw, may be prepared, and the electric power that needs to be supplied may be calculated directly based on the map, in order to omit the conversion process. This eliminates the necessity of performing the conversion process for converting the value of the pressure to the value of the electric power. Therefore, it is possible to simplify the processing in the ECU 30. The manner, in which the start-time feed pressure Pfs is treated in the third embodiment, may be similarly changed.

In the above-described embodiments, the coolant temperature Tw is used as the engine temperature. However, the temperature of lubricating oil may be used as the engine temperature.

1. A fuel supply apparatus for an internal combustion engine, comprising:
a high pressure fuel pump that is driven by an internal combustion engine, and that pressurizes fuel and supplies the fuel to the internal combustion engine;
an electrically-operated low pressure fuel pump that delivers the fuel to the high pressure fuel pump; and
a low pressure pump control portion that controls the low pressure fuel pump to avoid a discharge failure in the high pressure fuel pump due to insufficiency of a feed pressure at which the low pressure fuel pump delivers the fuel to the high pressure fuel pump, wherein the low pressure pump control portion stops the low pressure fuel pump in a case where the discharge failure in the high pressure fuel pump is avoided even when the feed pressure is equal to a gauge pressure of 0.

2. The fuel supply apparatus according to claim 1; further comprising
a feed pressure calculation portion that calculates a required feed pressure at which the discharge failure is avoided, based on a sum of a saturated vapor pressure of the fuel and pressure loss that occurs when the high pressure fuel pump sucks the fuel, wherein the low pressure pump control portion controls the low pressure fuel pump so that the fuel is delivered to the high pressure fuel pump at the required feed pressure calculated by the feed pressure calculation portion.

3. The fuel supply apparatus according to claim 2, wherein the low pressure pump control portion stops the low pressure fuel pump, when the required feed pressure calculated by the feed pressure calculation portion is equal to or lower than an atmospheric pressure.

4. The fuel supply apparatus according to claim 2 or 3, wherein
the high pressure fuel pump is provided with an adjustment portion that adjusts a fuel pressure that is a pressure of the fuel supplied to the internal combustion engine; and
the fuel supply apparatus further comprises a high pressure pump control portion that controls the adjustment portion by providing, for the adjustment portion, a controlled variable corresponding to a difference between an actual fuel pressure and a standard value of the fuel pressure so that the difference is decreased; and
a feed pressure correction portion that corrects the required feed pressure calculated by the feed pressure calculation portion, based on the controlled variable provided for the adjustment portion by the high pressure pump control portion.

5. The fuel supply apparatus according to claim 4, wherein
when the controlled variable is equal to or larger than a predetermined value, the feed pressure correction portion corrects the required feed pressure to increase the required feed pressure.

6. The fuel supply apparatus according to claim 4 or 5, wherein the feed pressure correction portion gradually corrects the required feed pressure to gradually decrease the required feed pressure, on a condition that the controlled variable is maintained in a predetermined range.

7. The fuel supply apparatus according to any one of claims 4 to 6, further comprising
a storage portion in which a feed pressure specifying portion is stored, wherein in the feed pressure specifying portion, values of the required feed pressure are set using, as parameters, an engine temperature that is a temperature of the internal combustion engine, and that is correlated with the saturated vapor pressure, and an engine speed that is correlated with the pressure loss; and
a learning portion in which the required feed pressure corrected by the feed pressure correction portion is stored in association with the engine temperature and the engine speed, wherein the learning portion performs a learning process that modifies the value of the required feed pressure set in the feed pressure specifying portion, based on the corrected required feed pressure that is stored in association with the engine temperature and the engine speed,
wherein the feed pressure calculation portion acquires the engine temperature and the engine speed, and calculates the required feed pressure based on the acquired engine temperature and the acquired engine speed, using the feed pressure specifying portion.

8. The fuel supply apparatus according to claim 7, further comprising
a stop portion that stops the learning portion from performing the learning process, when the engine temperature changes to an extent larger than a first predetermined extent.

9. The fuel supply apparatus according to claim 7, further comprising
a stop portion that stops the feed pressure correction portion from correcting the required feed pressure, and stops the learning portion from performing the learning process, when the engine speed changes to an extent larger than a second predetermined extent.

10. The fuel supply apparatus according to claim 1, further comprising
a start-time setting portion that sets a start-time feed pressure, at which the low pressure fuel pump delivers the fuel to the high pressure fuel pump when the internal combustion engine is started, to an upper limit value in a case where there is necessity of quickly increasing a fuel pressure provided by the high pressure fuel pump when the internal combustion engine is started, wherein the start-time setting portion sets the start-time feed pressure based on an engine temperature that is a temperature of the internal combustion engine, in a case where there is not the necessity,
wherein the low pressure pump control portion controls the low pressure fuel pump so that the fuel is delivered to the high pressure fuel pump at the start-time feed pressure set by the start-time setting portion when the internal combustion engine is started.

11. The fuel supply apparatus according to claim 10, wherein
in the case where there is not the necessity, the start-time setting portion sets the start-time feed pressure so that when the engine temperature is higher than an upper limit value of an ordinary temperature region, the start-time feed pressure increases as the engine temperature increases, and when the engine temperature is lower than a lower limit value of the ordinary temperature region, the start-time feed pressure increases as the engine temperature decreases.

12. The fuel supply apparatus according to claim 11, wherein
the start-time setting portion sets the start-time feed pressure to a constant value when the engine temperature is in the ordinary temperature region.

13. A fuel supply method for an internal combustion engine, in which fuel is delivered to a high pressure fuel pump driven by an internal combustion engine, using an electrically-operated low pressure fuel pump, and the fuel pressurized by the high pressure fuel pump is supplied to the internal combustion engine, the fuel supply method comprising
calculating a required feed pressure at which a discharge failure in the high pressure fuel pump due to insufficiency of a feed pressure is avoided, based on a sum of a saturated vapor pressure of the fuel and pressure loss that occurs when the high pressure fuel pump sucks the fuel, wherein the feed pressure is a pressure at which the low pressure fuel pump delivers the fuel to the high pressure fuel pump;
controlling the low pressure fuel pump so that the fuel is delivered to the high pressure fuel pump at the required feed pressure that is calculated; and
stopping the low pressure fuel pump in a case where the discharge failure in the high pressure fuel pump is avoided even when the feed pressure is equal to a gauge pressure of 0.

14. The fuel supply method according to claim 13, wherein
the high pressure fuel pump is provided with an adjustment portion that adjusts a fuel pressure that is a pressure of the fuel supplied to the internal combustion engine; and
the fuel supply method further comprises:
controlling the adjustment portion by providing, for the adjustment portion, a controlled variable corresponding to a difference between an actual fuel pressure and a standard value of the fuel pressure so that the difference is decreased; and
correcting the calculated required feed pressure, based on the controlled variable provided for the adjustment portion.

15. The fuel supply method according to claim 13, further comprising
determining whether the internal combustion engine has been started, or the internal combustion engine is being started;
determining whether there is necessity of quickly increasing a fuel pressure provided by the high pressure fuel pump, if it is determined that the internal combustion engine is being started;
setting a start-time feed pressure, at which the low pressure fuel pump delivers the fuel to the high pressure fuel pump at a time of start of the internal combustion engine, to an upper limit value, if it is determined that there is the necessity, and setting the start-time feed pressure based on an engine temperature that is a temperature of the internal combustion engine, if it is determined that there is not the necessity; and
controlling the low pressure fuel pump so that the fuel is delivered to the high pressure fuel pump at the set start-time feed pressure.
